(19) United States
(12) Patent Application Publication
(10) Pub. No.: US 2014/0297000 A1
(43) Pub. Date: Oct. 2, 2014

(54) CONTROL SYSTEM, CONTROL DEVICE, CONNECTING LINE, AND DRIVE DEVICE

(71) Applicant: Kotaro Sugisawa, Chiyoda-ku (JP)

(72) Inventor: Kotaro Sugisawa, Chiyoda-ku (JP)

(73) Assignee: MITSUBISHI ELECTRIC CORPORATION, Chiyoda-ku, Tokyo (JP)

(21) Appl. No.: 14/358,290

(22) PCT Filed: Nov. 30, 2011
(86) PCT No.: PCT/JP2011/077685

§ 371 Date: May 15, 2014

(51) Int. Cl. G05B 9/02

(52) U.S. Cl. CPC G05B 9/02
USPC 700/12

(57) ABSTRACT

A control system includes: a control device that controls operations of a drive device; and a connecting line that connects the control device and the drive device. The control device includes: a ready-on unit configured to output a ready-on signal that permits the drive device to operate; a safety device configured to control output of the ready-on signal based on the ready-on signal input from the ready-on unit and a connection state of the connecting line; and a control unit configured to supply power to the drive device and to control operations of the drive device based on a ready-on signal input from the safety device. The connecting line includes an attachment/detachment determination line that outputs a signal input from the safety device to the safety device in return.

### FIELD

The present invention relates to a control system that controls operations of a drive device.

### BACKGROUND

Conventionally, in a system that controls a drive device such as an industrial robot, a control device controls power supplied to the drive device so as to control operations of the drive device. Patent Literature 1 mentioned below discloses a technique in which a teaching operation panel is connected to a control device so as to control a drive device from the teaching operation panel for protection of an operator. The control device can control the supply of power to the teaching operation panel upon confirming the connection state of the teaching operation panel, and can attach or detach the teaching operation panel without stopping the operation of the drive device.

### CITATION LIST

### Patent Literature

Patent Literature 1: Japanese Patent Application Laid-open No. 2002-127075

### SUMMARY

### Technical Problem

However, according to the conventional technique mentioned above, the control device can determine that the drive device is controllable even if a connecting line for connecting the control device to the drive device is not connected to the control device. When the connecting line is not connected, in the control device, a high-voltage terminal part of a connection unit connected to the connecting line for supplying power to the drive device is exposed. Therefore, there is a risk that a person may touch the high-voltage terminal part. A person may easily touch the high-voltage terminal part of the control device depending on the connector shape and the position of the connection unit of the control device.

The present invention has been made to solve the above problems, and an object of the present invention is to provide a control system capable of preventing a connection unit of a control device from being turned into a high voltage state when the connection unit is exposed due to a connecting line for connecting the control device to a drive device is not connected.

### Solution to Problem

To solve the above described problems and achieve the object a control system includes: a control device that controls operations of a drive device; and a connecting line that connects the control device and the drive device. The control device includes: a ready-on unit configured to output a ready-on signal that permits the drive device to operate; a safety device configured to control output of the ready-on signal based on the ready-on signal input from the ready-on unit and a connection state of the connecting line; and a control unit configured to supply power to the drive device and to control operations of the drive device based on a ready-on signal input from the safety device. The connecting line includes an attachment/detachment determination line that outputs a signal input from the safety device to the safety device in return.

### Advantageous Effects of Invention

The control system according to the present invention can prevent a connection unit of a control device from being turned into a high voltage state when the connection unit is exposed due to a connecting line for connecting the control device to the drive device is not connected.

### BRIEF DESCRIPTION OF DRAWINGS

FIG. 1 is a configuration example of a control system according to a first embodiment.

FIG. 2 is a flowchart of processes for transitioning into a ready-on state in a control device.

FIG. 3 is a configuration example of a safety device according to the first embodiment.

FIG. 4 is a configuration example of a control system according to a second embodiment.

FIG. 5 is a configuration example of a control system according to a third embodiment.

FIG. 6 is a configuration example of a safety device according to the third embodiment.

FIG. 7 is a configuration example of a control system according to a fourth embodiment.

### DESCRIPTION OF EMBODIMENTS

Exemplary embodiments of a control system according to the present invention will be explained below in detail with reference to the accompanying drawings. The present invention is not limited to the embodiments.

### First Embodiment

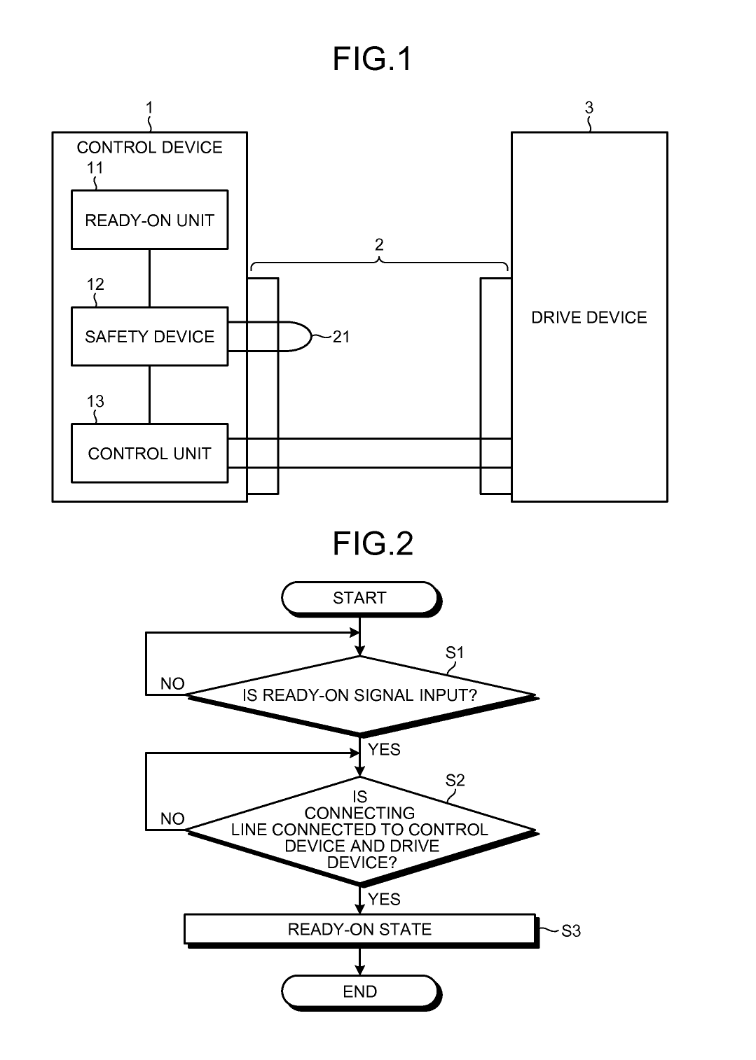

FIG. 1 is a configuration example of a control system according to the present embodiment. The control system includes a control device 1, a connecting line 2, and a drive device 3.

The control device 1 controls operations of the drive device 3 via the connecting line 2. The control device 1 includes: a ready-on unit 11 that has a circuit configuration equivalent to that of a conventional ready-on circuit and that outputs a ready-on signal that allows the drive device 3 to operate; a safety device 12 that controls the ready-on signal output to a control unit 3 based on the ready-on signal from the ready-on unit 11 and a connection state of the connecting line 2; and a control unit 13 that has a circuit configuration equivalent to that of a conventional main circuit executing a control and that supplies power to the drive device 3 and controls operations of the drive device 3 based on the ready-on signal input from the safety device 12. Configurations equivalent to the conventional configurations may be applied to the circuit configurations of the ready-on unit 11 and the control unit 13.

The connecting line 2 is a cable that connects between the control device 1 and the drive device 3 and that includes a power supply line for supplying power from the control device 1 to the drive device 3. The connecting line 2 includes an attachment/detachment determination line 21 used by the safety device 12 of the control device 1 to confirm the connection state of the connecting line 2. The attachment/detachment determination line 21 outputs a signal input from the safety device 12 of the control device 1 to the safety device 12 of the control device 1 by return.

The drive device 3 is a control target device in the present system.

A ready-on state control executed by the control device 1 will be explained next. FIG. 2 is a flowchart of processes for transitioning into a ready-on state in the control device 1. First, the ready-on unit 11 outputs a ready-on signal to the safety device 12 when allowing the drive device 3 to operate. The safety device 12 stands by until the ready-on signal is input from the ready-on unit 11 (NO at Step S1), and when the ready-on signal is input to the safety device 12 (YES at Step S1), the safety device 12 then confirms whether the connecting line 2 is connected (Step S2).

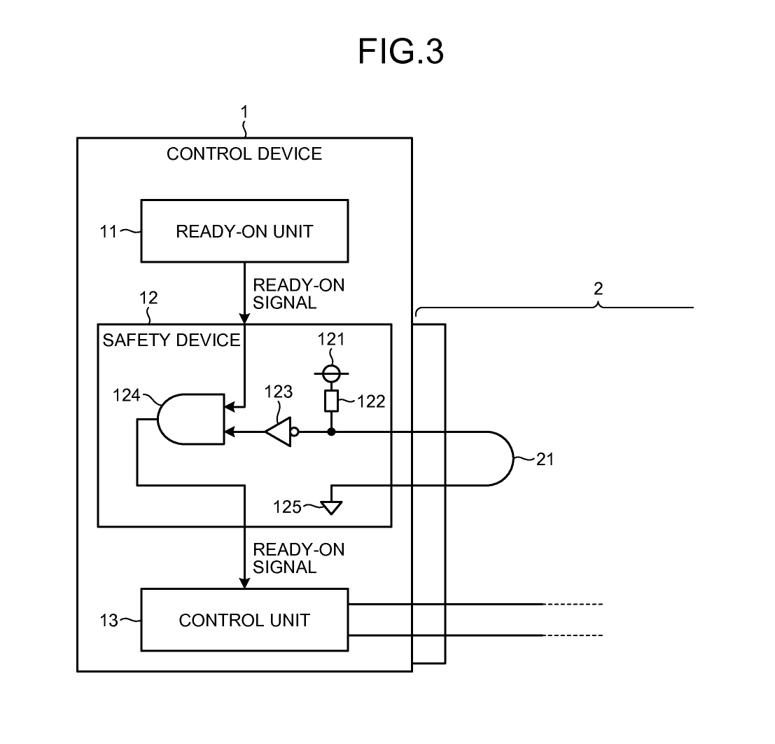

A specific configuration of the safety device 12 is explained here. FIG. 3 is a configuration example of the safety device according to the present embodiment. The safety device 12 includes a power supply unit 121, a resistor unit 122, a logic inversion unit 123, an output determination unit 124, and a GND unit 125.

The power supply unit 121 applies a predetermined voltage to a connection determination signal to be input to the output determination unit 124. The power supply unit 121 preferably applies the voltage such that a voltage, at a time when the connection determination signal input to the output determination unit 124 via the logic inversion unit 123 is Hi, is almost equal to a voltage of the ready-on signal input to the output determination unit 124. The resistor unit 122 is a pull-up resistor arranged between the power supply unit 121 and the logic inversion unit 123. The logic inversion unit 123 logically inverts the connection determination signal from the connecting line 2 and outputs the logic-inverted connection determination signal to the output determination unit 124. The output determination unit 124 performs an AND operation on the input from the ready-on unit 11 and the logic inversion unit 123. The GND unit 125 is a ground that is a reference voltage for the safety device 12.

In the safety device 12, the output determination unit 124 detects Hi when the ready-on signal is input to the safety device 12 from the ready-on unit 11. Meanwhile, in a state where the connecting line 2 shown in FIG. 3 is connected, because an input terminal of the logical inversion unit 123 is connected to the GND unit 125 via the attachment/detachment determination line 21 of the connecting line 2 and is Low, the connection determination signal inverted from Low to Hi by the logical inversion unit 123 is input to the output determination unit 124. On the other hand, in a state where the connecting line 2 is not connected, because the input terminal of the logical inversion unit 123 is Hi, the connection determination signal logically inverted from Hi to Low by the logical inversion unit 123 is input to the output determination unit 124. In this manner, in the safety device 12, the output determination unit 124 can confirm whether the connecting line 2 is connected based on the signal from the logical inversion unit 123 (Step S2).

When the output determination unit 124 detects Low from the logical inversion unit 123, the safety device 12 determines that the connecting line 2 is not connected and stands by (NO at Step S2). When the output determination unit 124 detects Hi from the logical inversion unit 123, then the safety device 12 determines that the connecting line 2 is connected (YES at Step S2), the output determination unit 124 outputs the ready-on signal to the control unit 13 and turns the control unit 13 into a ready-on state (Step S3).

The control unit 13 is turned into a ready-on state based on the ready-on signal from the safety device 12, and supplies power to the drive device 3 via the connecting line 2 and controls operations of the drive device 3. As to how the control unit 13 controls operations of the drive device 3 is not limited to any specific method, and methods of conventional techniques can be used.

In this way, the control device 1 controls operations of the drive device 3 via the connecting line 2 only when the connecting line 2 is connected. That is, the control device 1 does not control operations of the drive device 3 in a state where the connecting line 2 is not connected. Therefore, even if the connecting line 2 is not connected and a connection unit of the control device 1 is exposed, any current for controlling the drive device 3 is not applied to the connection unit and the connection unit is not turned into a high voltage state. Accordingly, it is possible to prevent a person from touching the connection unit that is in a high voltage state.

When the output determination unit 124 detects Low from the logical inversion unit 123, that is, the connecting line 2 is not connected (NO at Step S2), the safety device 12 can finish the processes upon determining that the control device 1 is in an error state without standing by.

Furthermore, while a specific circuit configuration of the safety device 12 has been explained with reference to FIG. 3, the configuration is only an example and the specific circuit configuration of the safety device 12 is not limited to that shown in FIG. 3. As long as a signal can be output under equivalent conditions for the input of the ready-on signal and the connection state of the connecting line 2, a configuration of another logical circuit, a configuration other than that of the logical circuit or the like may be used.

Further, the control device 1 can be simply configured because the control device 1 is configured by adding the safety device 12 to conventional control devices (the ready-on unit 11 and the control unit 13).

As described above, according to the present embodiment, in the control device 1, the safety device 12 confirms the ready-on signal and the connection state of the connecting line 2 and outputs the ready-on signal to the control unit 13 when the ready-on signal is input to the safety device 12 and the connecting line 2 is connected, and the control unit 13 supplies power to the drive device 3 and controls operations of the drive device 3 based on the input ready-on signal. With this configuration, in the control device 1, when the connecting line 2 is not connected, then the control unit 13 is not turned into a ready-on state and does not supply power to the drive device 3. Therefore, it is possible to prevent the connection unit connected with the connecting line 2 from being exposed in a high voltage state.

### Second Embodiment

In the present embodiment, the drive device includes an attachment/detachment determination line. Parts different from the first embodiment will be explained below.

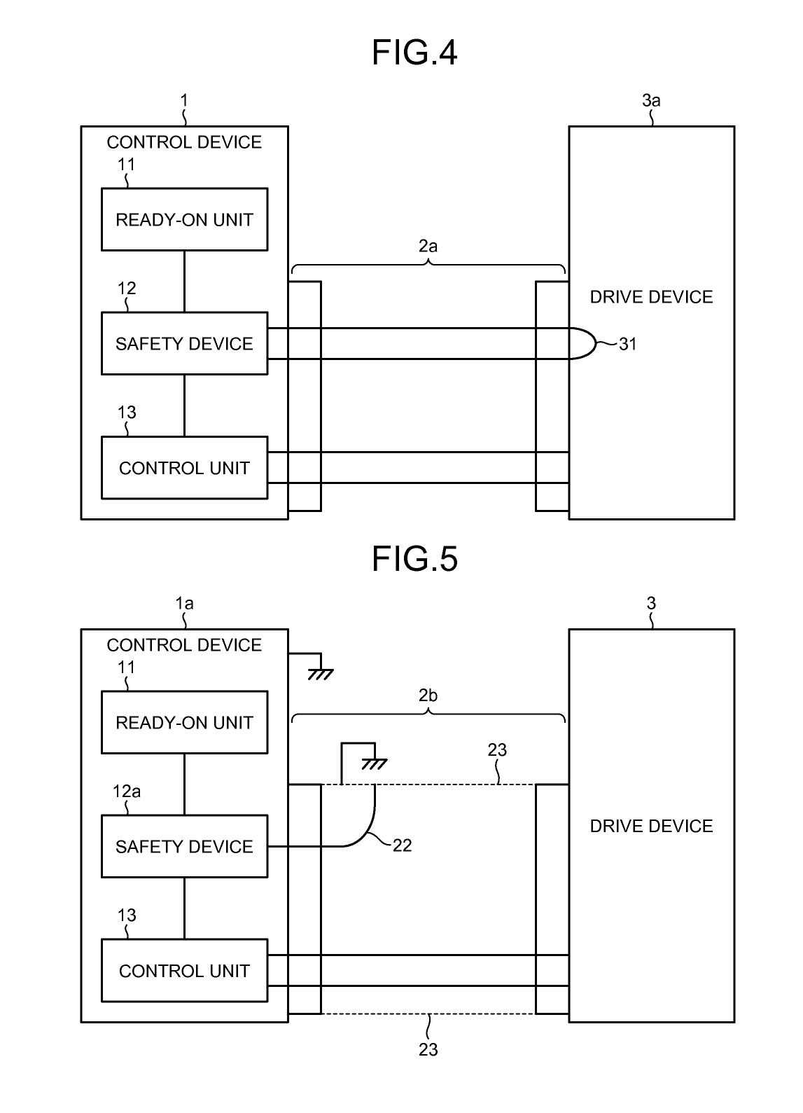

FIG. 4 is a configuration example of a control system according to the present embodiment. The control system includes the control device 1, a connecting line 2a, and a drive device 3a. The configuration of the control device 1 is identical to that of the first embodiment (see FIG. 3).

The connecting line 2a is a cable that connects the control device 1 and the drive device 3a and includes a power supply line from the control device 1 to the drive device 3a.

The drive device 3a is a control target device in the present system. The drive device 3a includes an attachment/detachment determination line 31 used by the safety device 12 of the control device 1 to confirm a connection state of the connecting line 2a. The attachment/detachment determination line 31 outputs a signal, input from the safety device 12 of the control device 1 via the connecting line 2a, to the safety device 12 of the control device 1 by return.

In the safety device 12, in a state where the connecting line 2a shown in FIG. 4 is connected, because the input terminal of the logical inversion unit 123 is connected to the GND unit 125 via the connecting line 2a and the attachment/detachment determination line 31 of the drive device 3a and is Low; the connection determination signal inverted from Low to Hi by the logical inversion unit 123 is input to the output determination unit 124. On the other hand, in a state where the connecting line 2a is not connected, because the input terminal of the logical inversion unit 123 is Hi, the connection determination signal logically inverted from Hi to Low by the logical inversion unit 123 is input to the output determination unit 124. Other operations of the present embodiment are identical to those of the first embodiment.

As described above, the control device 1 controls the ready-on state similarly to that according to the first embodiment. In the present embodiment, the connecting line 2a is a general cable and the drive device 3a includes the attachment/detachment determination line 31. Therefore, the control device 1 determines that the connecting line 21 is not connected and is not turned into a ready-on state, not only when the connecting line 2a is not connected but also when the connecting line 2a is broken.

As described above, according to the present embodiment, the drive device 3a includes the attachment/detachment determination line 31. With this configuration, in addition to the effects of the first embodiment, the control device 1 is not turned into a ready-on state and does not supply power to the drive device 3a even if the connecting line 2a is broken. Therefore, it is possible to prevent the broken portion from being exposed in a high voltage state.

### Third Embodiment

In the present embodiment, a case where a ground of a safety device is identical to an FG (Frame Ground) will be explained. Parts different from the first embodiment are explained below.

FIG. 5 is a configuration example of a control system according to the present embodiment. The control system includes a control device 1a, a connecting line 2b, and the drive device 3.

The control device 1a controls operations of the drive device 3 via the connecting line 2b. The control device 1a includes: the ready-on unit 11; a safety device 12a that controls a ready-on signal output to the control unit 3 based on a ready-on signal from the ready-on unit 11 and a connection state of the connecting line 2b; and the control unit 13. The control device 1a is connected to the FG via a casing or the like of the control device 1a and it is assumed that the ground of the safety device 12a is identical to the FG.

The connecting line 2b is a cable that connects the control device 1a and the drive device 3 and that includes a power supply line from the control device 1a to the drive device 3. The connecting line 2b includes an attachment/detachment determination line 22 used by the safety device 12a of the control device 1a to confirm the connection state of the connecting line 2b. Furthermore, the entire cable of the connecting line 2b is covered with a shield 23 and it is assumed that the connecting line 2b is connected to the FG via the shield 23. One end of the attachment/detachment determination line 22 is connected to the safety device 12a of the control device 1a and the other end thereof is connected to the FG via the shield 23.

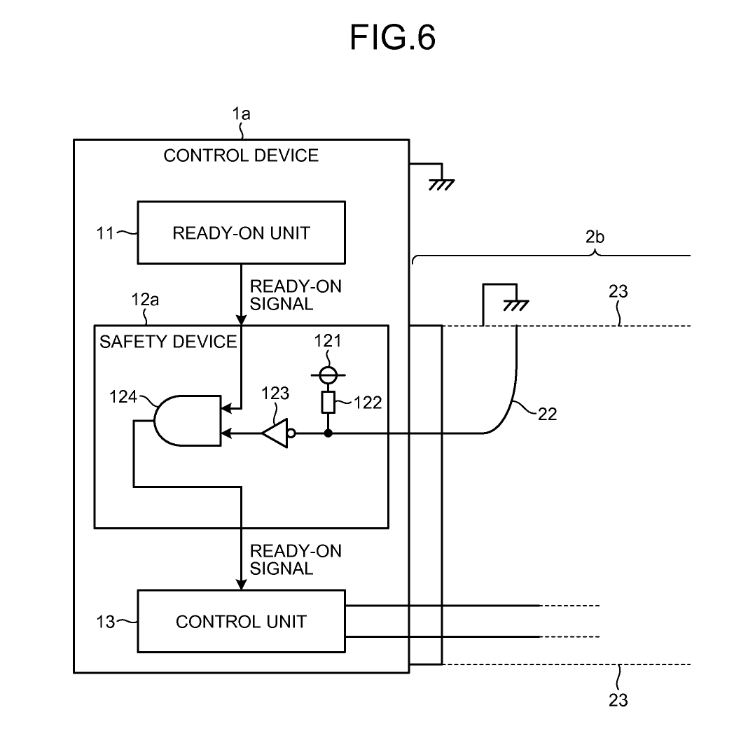

FIG. 6 is a configuration example of the safety device according to the present embodiment. The safety device 12a includes the power supply unit 121, the resistor unit 122, the logic inversion unit 123, and the output determination unit 124. The safety device 12a is configured by omitting the GND unit 125 from the safety device 12 (see FIG. 3).

In the safety device 12a, in a state where the connecting line 2b shown in FIG. 6 is connected, because the input terminal of the logical inversion unit 123 is connected to the FG via the attachment/detachment determination line 22 of the connecting line 2b and is Low, the connection determination signal inverted from Low to Hi by the logical inversion unit 123 is input to the output determination unit 124. On the other hand, in a state where the connecting line 2b is not connected, because the input terminal of the logical inversion unit 123 is Hi, the connection determination signal logically inverted from Hi to Low by the logical inversion unit 123 is input to the output determination unit 124. Other operations of the present embodiment are identical to those of the first embodiment.

As described above, according to the present embodiment, when the ground of the safety device 12a of the control device 1a is identical to the FG of the connecting line 2b, one end of the attachment/detachment determination line 22 is connected to the safety device 12a of the control device 1a and the other end thereof is connected to the FG without returning to the safety device 12a of the control device 1a. Even in this case, effects identical to those of the first embodiment can be achieved.

### Fourth Embodiment

In the present embodiment, a case where a ground of a safety device is identical to the FG of the drive device will be explained. Parts different from the second and third embodiments will be explained below.

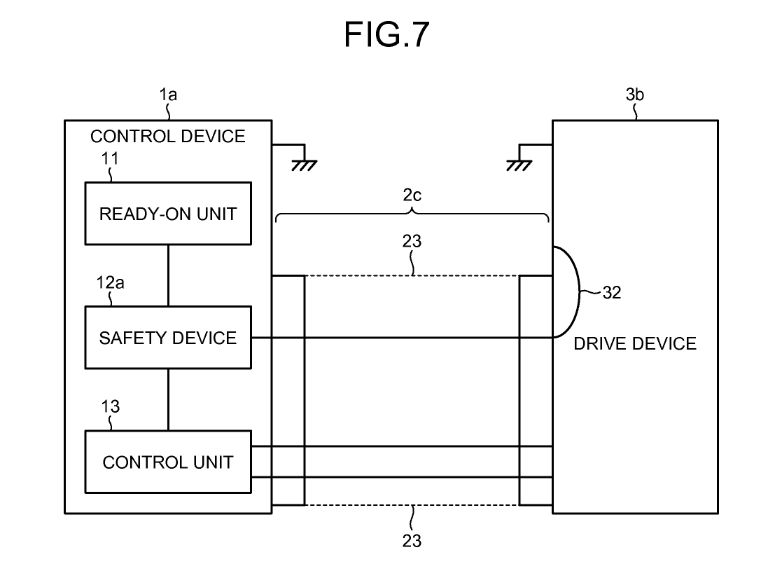

FIG. 7 is a configuration example of a control system according to the present embodiment. The control system includes the control device 1a, a connecting line 2c, and a drive device 3b.

The connecting line 2c is a cable that connects the control device 1a and the drive device 3b and that includes a power supply line from the control device 1a to the drive device 3b.

The drive device 3b is a control target device in the present system. The drive device 3b includes an attachment/detachment determination line 32 used by the safety device 12a of the control device 1a to confirm a connection state of the connecting line 2c. Furthermore, it is assumed that the drive device 3b is connected to the FG via a casing or the like of the drive device 3b. One end of the attachment/detachment determination line 32 is connected to the safety device 12a of the control device 1a via the connecting line 2c and the other end thereof is connected to the FG via a casing or the like of the drive device 3b.

In the safety device 12a, in a state where the connecting line 2c shown in FIG. 7 is connected, because the input terminal of the logical inversion unit 123 is connected to the FG via the attachment/detachment determination line 32 of the drive device 3b and is Low, the connection determination signal inverted from Low to Hi by the logical inversion unit 123 is input to the output determination unit 124. On the other hand, in a state where the connecting line 2c is not connected, because the input terminal of the logical inversion unit 123 is Hi, the connection determination signal logically inverted from Hi to Low by the logical inversion unit 123 is input to the output determination unit 124. Other operations of the present embodiment are identical to those of the second embodiment.

As described above, according to the present embodiment, when the ground of the safety device 12a of the control device 1a is identical to the FG of the drive device 3b, one end of the attachment/detachment determination line 32 is connected to the safety device 12a of the control device 1a via the connecting line 2c and the other end thereof is connected to the FG without returning to the safety device 12a of the control device 1a. Even in this case, effects identical to those of the second embodiment can be achieved.

### REFERENCE SIGNS LIST

1, 1a control device

2, 2a, 2b, 2c connecting line

3, 3a, 3b drive device

11 ready-on unit

12, 12a safety device

13 control unit

21, 22, 31, 32 attachment/detachment determination line

23 shield

121 power supply unit

122 resistor unit

123 logical inversion unit

124 output determination unit

125 GND unit

1. A control system comprising:
a control device that controls operations of a drive device; and
a connecting line that connects the control device and the drive device, wherein the control device includes:
a ready-on unit configured to output a ready-on signal that permits the drive device to operate;
a safety device configured to control output of the ready-on signal based on the ready-on signal input from the ready-on unit and a connection state of the connecting line; and
a control unit configured to supply power to the drive device and to control operations of the drive device based on a ready-on signal input from the safety device, wherein
the connecting line includes an attachment/detachment determination line that outputs a signal input from the safety device to the safety device in return.

2. A control system comprising:
a control device that controls operations of a drive device; and
the drive device that is connected to the control device via a connecting line, wherein
the control device includes:
a ready-on unit configured to output a ready-on signal that permits the drive device to operate;
a safety device configured to control output of the ready-on signal based on the ready-on signal input from the ready-on unit and a connection state of the connecting line; and
a control unit configured to supply power to the drive device and to control operations of the drive device based on a ready-on signal input from the safety device, wherein
the drive device includes an attachment/detachment determination line that outputs a signal input from the safety device, via the connecting line, to the safety device in return.

3. The control system according to claim 2, wherein the safety device includes:
a power supply unit that supplies power to one terminal that is connected to the attachment/detachment determination line;
a logical determination unit that inverts a logic of a signal voltage applied to the one terminal;
an output determination unit to which a ready-on signal from the ready-on unit and a signal from the logical determination unit are input, the output determination unit outputs a result of an AND operation to the control unit as a ready-on signal; and
a ground unit being a reference voltage connected to the other terminal that is connected to the attachment/detachment determination line, wherein
the attachment/detachment determination line connects the one terminal to the other terminal when the control device is connected to the connecting line or when the control device is connected to the drive device via the connecting line.

4. A control system comprising:
a control device that controls operations of a drive device; and
a connecting line that connects the control device and the drive device, wherein
when a ground of the control device is identical to a frame ground of the connecting line, the control device includes:
a ready-on unit that outputs a ready-on signal that allows the drive device to operate;
a safety device that controls output of the ready-on signal based on the ready-on signal input from the ready-on unit and a connection state of the connecting line; and
a control unit that supplies power to the drive device and controls operations of the drive device based on a ready-on signal input from the safety device, wherein
the connecting line includes an attachment/detachment determination line that connects a signal input from the safety device to the frame ground.

5. A control system comprising:
a control device that controls operations of a drive device; and
the drive device that is connected to the control device via a connecting line, wherein
when a ground of the control device is identical to a frame ground of the drive device, the control device includes:
a ready-on unit configured to output a ready-on signal that allows the drive device to operate;
a safety device that controls output of the ready-on signal based on the ready-on signal input from the ready-on unit and a connection state of the connecting line; and
a control unit that supplies power to the drive device and controls operations of the drive device based on a ready-on signal input from the safety device,
wherein
the drive device includes an attachment/detachment determination line that connects a signal input from the safety device via the connecting line to the frame ground.

6. The control system according to claim 5, wherein
the safety device includes:
a power supply unit that supplies power to a terminal that is connected to the attachment/detachment determination line;
a logical determination unit that inverts a logic of a signal voltage applied to the terminal; and
an output determination unit to which a ready-on signal from the ready-on unit and a signal from the logical determination unit are input, the output determination unit is configured to output a result of an AND operation to the control unit as a ready-on signal, wherein
the attachment/detachment determination line connects the terminal to the frame ground when the control device is connected to the connecting line or when the control device is connected to the drive device via the connecting line.

7. A control device connected to a drive device that is a control target via a connecting line, the control device comprising:
a ready-on unit that configured to output a ready-on signal that allows the drive device to operate;
a safety device configured to control output of the ready-on signal based on the ready-on signal input from the ready-on unit and a connection state of the connecting line; and
a control unit configured to supply power to the drive device and to control operations of the drive device based on a ready-on signal input from the safety device.

8. The control device according to claim 7, wherein
when at least one of the connecting line and the drive device includes an attachment/detachment determination line configured to output a signal input from the safety device to the safety device in return,
the safety device includes:
a power supply unit that supplies power to one terminal that is connected to the attachment/detachment determination line;
a logical determination unit that inverts a logic of a signal voltage applied to the one terminal;
an output determination unit to which a ready-on signal from the ready-on unit and a signal from the logical determination unit are input, the output determination unit is configured to output a result of an AND operation to the control unit as a ready-on signal; and
a ground unit that is a reference voltage connected to the other terminal that is connected to the attachment/detachment determination line.

9. The control device according to claim 7, wherein
when a ground of the control device is identical to a frame ground of at least one of the connecting line and the drive device, and when at least one of the connecting line and the drive device includes an attachment/detachment determination line that connects a signal input from the safety device to the frame ground,
the safety device includes:
a power supply unit configured to supply power to a terminal connected to the attachment/detachment determination line;
a logical determination unit configured to invert a logic of a signal voltage applied to the terminal; and
an output determination unit to which a ready-on signal from the ready-on unit and a signal from the logical determination unit are input, the output determination unit outputs a result of an AND operation to the control unit as a ready-on signal.

10. (canceled)

11. A connecting line configured to connect a control device that controls operations of a drive device and the drive device, wherein
when a ground of the control device is identical to a frame ground of the connecting line,
the connecting line comprises an attachment/detachment determination line that connects a signal input from the control device to the frame ground.

12. (canceled)

13. A drive device connected to a control device that controls operations of the drive device via a connecting line, wherein
when a ground of the control device is identical to a frame ground of the drive device,
the drive device comprises an attachment/detachment determination line that connects a signal input from the control device to the frame ground.

14. The control system according to claim 1, wherein
the safety device includes:
a power supply unit that supplies power to one terminal that is connected to the attachment/detachment determination line;
a logical determination unit that inverts a logic of a signal voltage applied to the one terminal;
an output determination unit to which a ready-on signal from the ready-on unit and a signal from the logical determination unit are input, the output determination unit outputs a result of an AND operation to the control unit as a ready-on signal; and
a ground unit being a reference voltage connected to the other terminal that is connected to the attachment/detachment determination line, wherein
the attachment/detachment determination line connects the one terminal to the other terminal when the control device is connected to the connecting line or when the control device is connected to the drive device via the connecting line.

15. The control system according to claim 4, wherein
the safety device includes:
a power supply unit that supplies power to a terminal that is connected to the attachment/detachment determination line;
a logical determination unit that inverts a logic of a signal voltage applied to the terminal; and
an output determination unit to which a ready-on signal from the ready-on unit and a signal from the logical determination unit are input, the output determination unit is configured to output a result of an AND operation to the control unit as a ready-on signal, wherein
the attachment/detachment determination line connects the terminal to the frame ground when the control device is connected to the connecting line or when the control device is connected to the drive device via the connecting line.
